(19) United States
(12) Patent Application Publication
(10) Pub. No.: US 2025/0280305 A1
(43) Pub. Date: Sep. 4, 2025

(54) METHOD AND APPARATUS FOR PRESENTING AI AND ML MEDIA SERVICES IN WIRELESS COMMUNICATION SYSTEM

(71) Applicant: Samsung Electronics Co., Ltd., Gyeonggi-do (KR)

(72) Inventors: Eric YIP, Gyeonggi-do (KR); Hyunkoo YANG, Gyeonggi-do (KR)

(21) Appl. No.: 18/862,838

(22) PCT Filed: May 3, 2023
(86) PCT No.: PCT/KR2023/006076

§ 371 Date: Nov. 4, 2024

(30) Foreign Application Priority Data
May 4, 2022 (KR) 10-2022-0055425

(51) Int. Cl. H04W 24/02; H04W 24/10

(52) U.S. Cl. CPC H04W 24/02; H04W 24/10

(57) ABSTRACT

The present disclosure relates to a 5G or 6G communication system for supporting higher data rates. According to various embodiments of the present disclosure, a method performed by a user equipment (UE) in a wireless communication system, the method comprising: receiving, from a first network entity, information regarding at least one artificial intelligence (AI) model; determining an AI model based on the information regarding at least one AI model; determining whether to use the AI model for an AI split inference service; requesting, to the first network entity, the AI split inference service; establishing an AI model deliver pipeline for the AI model; and establishing a media deliver pipeline for delivering media data used in the AI model.

### TECHNICAL FIELD

The present disclosure relates generally to a wireless communication system, and more particularly to a method and apparatus for presenting artificial intelligence (AI) and machine learning (ML) media services in a wireless communication system.

### BACKGROUND ART

5th generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

Based on the above discussion, various embodiments of the present disclosure are to present a method and apparatus for providing artificial intelligence (AI) and machine learning (ML) media services in a wireless communication system.

### Solution to Problem

According to an aspect of an exemplary embodiment, there is provided a communication method in a wireless communication.

### Advantageous Effects of Invention

Various embodiments of the present disclosure may present a method and apparatus for presenting artificial intelligence (AI) and machine learning (ML) media services in a wireless communication system.

Effects obtainable in the present disclosure are not limited to the effects mentioned above, and other effects not mentioned may be clearly understood by those skilled in the art from the description below.

### BRIEF DESCRIPTION OF DRAWINGS

FIG. 1 illustrates a wireless communication system according to various embodiments of the present disclosure.

FIG. 2 illustrates a construction of a base station in a wireless communication system according to various embodiments of the present disclosure.

FIG. 3 illustrates a construction of a terminal in a wireless communication system according to various embodiments of the present disclosure.

FIG. 4 illustrates the overall 5G media streaming architecture of TS 26.501, according to various embodiments of the present disclosure.

FIG. 5 illustrates the 5G media streaming general architecture of TS 26.501, according to various embodiments of the present disclosure.

FIG. 6 illustrates an example of a procedure for media downlink streaming specified in TS 26.501, according to various embodiments of the present disclosure.

FIG. 7 illustrates a baseline procedure describing the establishment of a unicast media downlink streaming session defined in TS 26.501, according to various embodiments of the present disclosure.

FIG. 8 illustrates an example of an AI/ML media service scenario where an AI/ML model must be delivered from a network to a UE (end device), according to various embodiments of the present disclosure.

FIG. 9 illustrates an example of a scenario where an AI model is delivered to a UE and where media (e.g., video) is streamed to the UE, according to various embodiments of the present disclosure.

FIG. 10 illustrates an example of a scenario where inferencing required for an AI media service is split between a network and a UE, according to various embodiments of the present disclosure.

FIG. 11 illustrates an example of an AI for media (AI4Media) architecture that identifies various functional entities and interfaces for enabling AI model delivery for media services in a wireless communication system according to various embodiments of the present disclosure.

FIG. 12 illustrates an example of a procedure for AL model downlink delivery corresponding to the scenario of FIG. 8 in a wireless communication system according to various embodiments of the present disclosure.

FIG. 13 illustrates a basic workflow procedure for the scenario of FIG. 8 in a wireless communication system according to various embodiments of the present disclosure.

FIG. 14A illustrates an example of various AI model delivery pipelines obtained in step 4 of FIG. 13 in a wireless communication system according to various embodiments of the present disclosure.

FIG. 14B illustrates an example of various AI model delivery pipelines obtained in step 4 of FIG. 13 in a wireless communication system according to various embodiments of the present disclosure.

FIG. 15 illustrates an example of a procedure for AL model downlink delivery and media content streaming delivery corresponding to the scenario of FIG. 9 in a wireless communication system according to various embodiments of the present disclosure.

FIG. 16 illustrates a basic workflow procedure for the scenario of FIG. 9, which is an extension of the basic workflow procedure described in FIG. 13 in a wireless communication system according to various embodiments of the present disclosure.

FIG. 17 illustrates an example of a procedure for a split inferencing AI media service corresponding to the scenario of FIG. 10 in a wireless communication system according to various embodiments of the present disclosure.

FIG. 18 illustrates a basic workflow procedure for the scenario of FIG. 9 in a wireless communication system according to various embodiments of the present disclosure.

### BEST MODE FOR CARRYING OUT THE INVENTION

According to various embodiments of the present disclosure, it presents a method performed by a user equipment (UE) in a wireless communication system, the method comprising receiving, from a first network entity, information regarding at least one artificial intelligence (AI) model, determining an AI model based on the information regarding at least one AI model, determining whether to use the AI model for an AI split inference service, requesting, to the first network entity, the AI split inference service, establishing an AI model deliver pipeline for the AI model, and establishing a media deliver pipeline for delivering media data used in the AI model.

The information regarding at least one AI model includes a uniform resource locator (URL) to obtain a list the at least one AI model.

The method may further include receiving, from a second network entity, intermediate data on the media deliver pipeline.

The method may further include transmitting, to the first network function, a status report regarding information on the AI split inference service.

The method may further include updating the AI model and the AI model deliver pipeline based on the information on the AI split inference service and information on a network status.

According to various embodiments of the present disclosure, it presents a method performed by a first network entity in a wireless communication system, the method comprising: transmitting, to a user equipment (UE), information regarding at least one artificial intelligence (AI) model, identifying an AI model determined based on the information regarding at least one AI model, receiving a request for an AI split inference service using the AI model, establishing an AI model deliver pipeline for the AI model, and establishing a media deliver pipeline for delivering media data used in the AI model.

The information regarding at least one AI model includes a uniform resource locator (URL) to obtain a list the at least one AI model.

The method may further include receiving, from the UE, a status report regarding information on the AI split inference service.

The method may further include updating the AI model and the AI model deliver pipeline based on the information on the AI split inference service and information on a network status.

The method may further include triggering an inference process in a second network entity.

According to another embodiment of the disclosure, a user equipment (UE) in a wireless communication system, the UE comprising: at least one transceiver; and at least one processor operatively coupled with the at least one transceiver, wherein the at least one processor is configured to: receive, from a first network entity, information regarding at least one artificial intelligence (AI) model, determine an AI model based on the information regarding at least one AI model, determine whether to use the AI model for an AI split inference service, request, to the first network entity, the AI split inference service, establish an AI model deliver pipeline for the AI model, and establish a media deliver pipeline for delivering media data used in the AI model.

The information regarding at least one AI model includes a uniform resource locator (URL) to obtain a list the at least one AI model.

The at least one processor is further configured to receive, from a second network entity, intermediate data on the media deliver pipeline.

The at least one processor is further configured to transmit, to the first network function, a status report regarding information on the AI split inference service.

The at least one processor is further configured to update the AI model and the AI model deliver pipeline based on the information on the AI split inference service and information on a network status.

According to another embodiment of the disclosure, a first network entity in a wireless communication system, the first network entity comprising: at least one transceiver; and at least one processor operatively coupled with the at least one transceiver, wherein the at least one processor is configured to: transmit, to a user equipment (UE), information regarding at least one artificial intelligence (AI) model, identify an AI model determined based on the information regarding at least one AI model, receive a request for an AI split inference service using the AI model, establish an AI model deliver pipeline for the AI model, and establish a media deliver pipeline for delivering media data used in the AI model.

The information regarding at least one AI model includes a uniform resource locator (URL) to obtain a list the at least one AI model.

The at least one processor is further configured to receive, from the UE, a status report regarding information on the AI split inference service.

The at least one processor is further configured to update the AI model and the AI model deliver pipeline based on the information on the AI split inference service and information on a network status.

The at least one processor is further configured to trigger an inference process in a second network entity.

### Mode for the Invention

Terms used in the present disclosure are only used to describe a specific embodiment, and may not be intended to limit the scope of other embodiments. Singular expressions may include plural expressions unless the context clearly dictates otherwise. Terms used herein, including technical or scientific terms, may have the same meaning as those commonly understood by a person having an ordinary skill in the art described in the present disclosure. Among the terms used in the present disclosure, terms defined in general dictionaries may be interpreted as having the same or similar meanings as those in the context of the related art, and unless explicitly defined in the present disclosure, are not be interpreted as ideal or excessively formal meanings. In some cases, even terms defined in the present disclosure may not be interpreted to exclude embodiments of the present disclosure.

In various embodiments of the present disclosure described below, a hardware access method is described as an example. However, since various embodiments of the present disclosure include a technology using both hardware and software, the various embodiments of the present disclosure do not exclude a software-based access method.

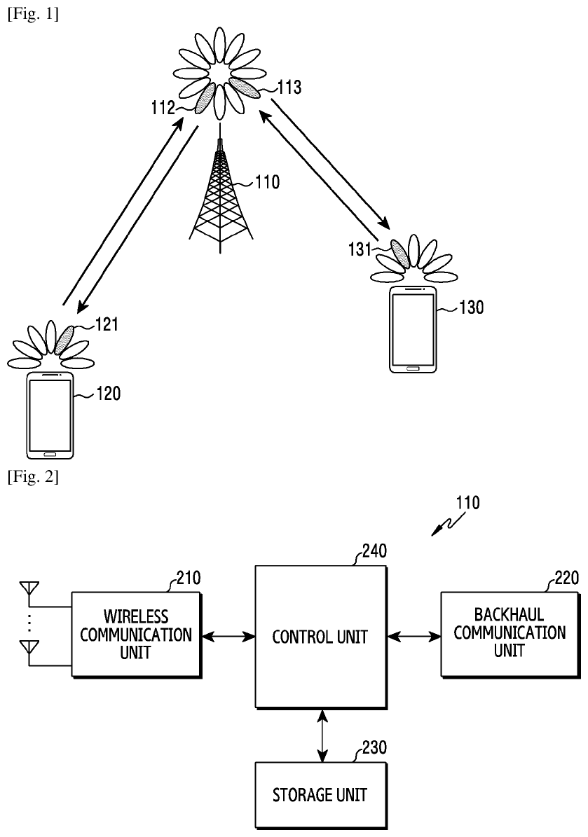

FIG. 1 illustrates a wireless communication system according to various embodiments of the present disclosure. FIG. 1 illustrates a base station 110, a terminal 120, and a terminal 130, as some of nodes using a wireless channel, in a wireless communication system. Although FIG. 1 illustrates only one base station, other base stations identical or similar to the base station 110 may be further included.

The base station 110 is a network infrastructure that presents wireless access to the terminals 120 and 130. The base station 110 has coverage defined as a certain geographical area based on a distance over which signals may be transmitted. The base station 110 may be referred to as, in addition to base station, ‘access point (AP)’, ‘eNodeB (eNB)’, ‘5th generation node (5G node)’, ‘next generation nodeB (gNB)’, ‘wireless point’, ‘transmission/reception point (TRP)’, or other terms having an equivalent technical meaning.

Each of the terminal 120 and the terminal 130 is a device used by a user and communicates with the base station 110 through a wireless channel. In some cases, at least one of the terminal 120 and the terminal 130 may be operated without user's involvement. That is, at least one of the terminal 120 and the terminal 130 is a device that performs machine type communication (MTC), and may not be carried by the user. Each of the terminal 120 and the terminal 130 may be referred to as, in addition to terminal, ‘user equipment (UE)’, ‘mobile station’, ‘subscriber station’, ‘remote terminal’, ‘wireless terminal’, ‘user device’, or other terms having an equivalent technical meaning.

The base station 110, the terminal 120, and the terminal 130 may transmit and receive wireless signals in a mmWave band (e.g., 28 GHz, 30 GHz, 38 GHz, and 60 GHz). At this time, in order to improve a channel gain, the base station 110, the terminal 120, and the terminal 130 may perform beamforming. Here, the beamforming may include transmit beamforming and receive beamforming. That is, the base station 110, the terminal 120, and the terminal 130 may give directivity to a transmitted signal or a received signal. To this end, the base station 110 and the terminals 120 and 130 may select serving beams 112, 113, 121 and 131 through a beam search or beam management procedure. After the serving beams 112, 113, 121, and 131 are selected, communication may be performed through resources being in a quasi co-located (QCL) relationship with resources transmitted the serving beams 112, 113, 121, and 131.

When the large-scale characteristics of a channel delivering a symbol on a first antenna port may be inferred from a channel delivering a symbol on a second antenna port, the first antenna port and the second antenna port may be evaluated to be in a QCL relationship. For example, the large-scale characteristics may include at least one of delay spread, Doppler spread, Doppler shift, average gain, average delay, and spatial receiver parameter.

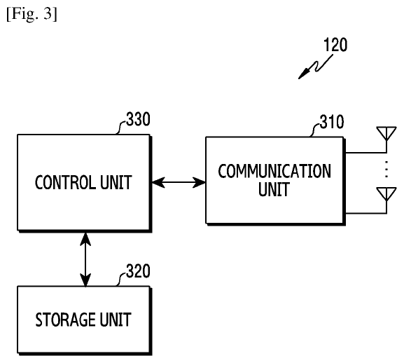

FIG. 2 illustrates a construction of a base station in a wireless communication system according to various embodiments of the present disclosure. The construction illustrated in FIG. 2 may be understood as a construction of the base station 110. Terms such as ‘˜unit’ and ‘˜part’ used below refer to a unit that processes at least one function or operation, and may be implemented by hardware or software, or a combination of hardware and software.

Referring to FIG. 2, the base station includes a wireless communication unit 210, a backhaul communication unit 220, a storage unit 230, and a control unit 240.

The wireless communication unit 210 performs functions for transmitting and receiving signals through a wireless channel. For example, the wireless communication unit 210 performs a conversion function between a baseband signal and a bit stream according to the physical layer standard of the system. For example, when transmitting data, the wireless communication unit 210 provides complex symbols by encoding and modulating a transmission bit stream. Also, when receiving data, the wireless communication unit 210 restores a reception bit stream by demodulating and decoding a baseband signal.

Also, the wireless communication unit 210 up-converts a baseband signal into a radio frequency (RF) band signal, transmits the signal through an antenna, and down-converts an RF band signal received through the antenna into a baseband signal. To this end, the wireless communication unit 210 may include a transmit filter, a receive filter, an amplifier, a mixer, an oscillator, a digital to analog converter (DAC), an analog to digital converter (ADC), and the like. Also, the wireless communication unit 210 may include a plurality of transmission and reception paths. Furthermore, the wireless communication unit 210 may include at least one antenna array composed of a plurality of antenna elements.

In terms of hardware, the wireless communication unit 210 may consist of a digital unit and an analog unit, and the analog unit may consist of a plurality of sub-units according to operating power, operating frequency, etc. The digital unit may be implemented as at least one processor (e.g., a digital signal processor (DSP)).

The wireless communication unit 210 transmits and receives signals as described above. Accordingly, all or part of the wireless communication unit 210 may be referred to as a ‘transmitter’, a ‘receiver’, or a ‘transceiver’. Also, in the following description, transmission and reception performed through a wireless channel are used as a meaning including that the above-described processing is performed by the wireless communication unit 210.

The backhaul communication unit 220 presents an interface for communicating with other nodes in a network. That is, the backhaul communication unit 220 converts a bit stream transmitted from the base station to another node, for example, another access node, another base station, an upper node, a core network, etc., into a physical signal, and converts a physical signal received from another node into a bit stream.

The storage unit 230 stores data such as basic programs for operation of the base station, application programs, setting information, etc. The storage unit 230 may consist of a volatile memory, a non-volatile memory, or a combination of volatile and non-volatile memories. And, the storage unit 230 presents the stored data according to the request of the control unit 240.

The control unit 240 controls overall operations of the base station. For example, the control unit 240 transmits and receives signals through the wireless communication unit 210 or the backhaul communication unit 220. Also, the control unit 240 writes and reads data in the storage unit 230. And, the control unit 240 may perform functions of a protocol stack required by communication standards. According to another implementation example, the protocol stack may be included in the wireless communication unit 210. To this end, the control unit 240 may include at least one processor.

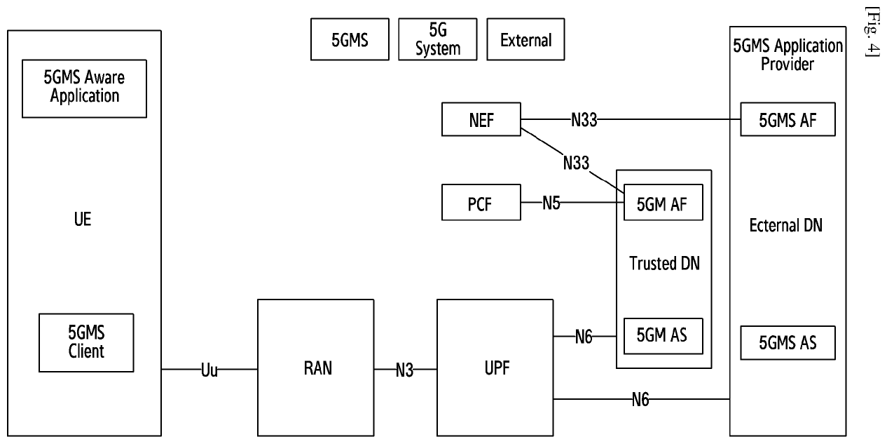

FIG. 3 illustrates a construction of a terminal in a wireless communication system according to various embodiments of the present disclosure. The construction illustrated in FIG. 3 may be understood as the construction of the terminal 120. Terms such as ‘˜unit’ and ‘˜part’ used below refer to a unit that processes at least one function or operation, and may be implemented by hardware or software, or a combination of hardware and software.

Referring to FIG. 3, the terminal includes a communication unit 310, a storage unit 320, and a control unit 330.

The communication unit 310 performs functions for transmitting and receiving signals through a wireless channel. For example, the communication unit 310 performs a conversion function between a baseband signal and a bit stream according to the physical layer standard of the system. For example, when transmitting data, the communication unit 310 provides complex symbols by encoding and modulating a transmission bit stream. Also, when receiving data, the communication unit 310 restores a reception bit stream by demodulating and decoding a baseband signal. Also, the communication unit 310 up-converts a baseband signal into an RF band signal, transmits the signal through an antenna, and down-converts an RF band signal received through the antenna into a baseband signal. For example, the communication unit 310 may include a transmit filter, a receive filter, an amplifier, a mixer, an oscillator, a DAC, an ADC, and the like.

Also, the communication unit 310 may include a plurality of transmission/reception paths. Furthermore, the communication unit 310 may include at least one antenna array consisting of a plurality of antenna elements. In terms of hardware, the communication unit 310 may consist of a digital circuit and an analog circuit (e.g., a radio frequency integrated circuit (RFIC)). Here, the digital circuit and the analog circuit may be implemented in one package. Also, the communication unit 310 may include a plurality of RF chains. Furthermore, the communication unit 310 may perform beamforming.

The communication unit 310 transmits and receives signals as described above. Accordingly, all or part of the communication unit 310 may be referred to as a ‘transmitter’, a ‘receiver’ or a ‘transceiver’. Also, in the following description, transmission and reception performed through a wireless channel are used as a meaning including that the above-described processing is performed by the communication unit 310.

The storage unit 320 stores data such as basic programs for operation of the terminal, application programs, setting information, etc. The storage unit 320 may consist of a volatile memory, a non-volatile memory, or a combination of volatile and non-volatile memories. And, the storage unit 320 presents the stored data according to the request of the control unit 330.

The control unit 330 controls overall operations of the terminal. For example, the control unit 330 transmits and receives signals through the communication unit 310. Also, the control unit 330 writes and reads data in the storage unit 320. Also, the control unit 330 may perform functions of a protocol stack required by communication standards. To this end, the control unit 330 may include at least one processor or microprocessor, or may be a part of the processor. Also, a part of the communication unit 310 and the control unit 330 may be referred to as a communication processor (CP).

Various embodiments of the present disclosure relate to the following subject matter:

Mechanisms for split AI (artificial intelligence)/ML (machine learning) inferencing media services

Fields of technology of various embodiments of the present disclosure include:

5G network systems for multimedia, architectures and procedures for AI/ML model transfer and delivery over 5G, AI/ML model transfer and delivery over 5G for AI enhanced multimedia services.

The background technology of various embodiments of the present disclosure includes the following:

Artificial Intelligence (AI) is a general concept defining the capability for a system to act based on 2 major conditions:
The context in which a task has to be done, meaning the value or state of different input parameters.
The past experience of achieving the same task with different parameter values and the record of potential success with each parameter value.

Machine Learning (ML) is often described as a subset of AI, in which an application has the capacity to learn from the past experience. This learning feature usually starts with an initial training phase so as to ensure a minimum level of performance when it is placed into service.

Recently, AI/ML has been introduced and generalized in media related applications, ranging from legacy applications such as image classification, speech/face recognition, to more recent ones such as video quality enhancement. As research into this field matures, more and more complex AI/ML-based applications requiring higher computational processing can be expected; such processing involves dealing with significant amounts of data not only for the inputs and outputs into the AI/ML models, but also for the increasing data size and complexity of the AI/ML models themselves. This growing amount of AI/ML related data, together with a need for supporting processing intensive mobile applications (such as VR, AR/MR, gaming, and more), highlights the importance of handling certain aspects of AI/ML processing by the server over 5G system, in order to meet the required latency requirements of various applications.

Problems with existing technology in various embodiments of the present disclosure include the following:

Current implementations of AI/ML are mainly proprietary solutions, enabled via applications without compatibility with other market solutions. In order to support AI/ML for multimedia applications over 5G, AI/ML models should support compatibility between UE devices and application providers from different MNOs. Not only this, but AI/ML model delivery for AI/ML media services should support media context, UE status, and network status based selection and delivery of the AI/ML model. The processing power of UE devices is also a limitation for AI/ML media services, since next generation media services, such as AR, are typically consumed on lightweight, low processing power devices, such as AR glasses, for which long battery life is also a major design hurdle/limitation.

The object of invention as solution(s) to the problem(s) in the various embodiments of the present disclosure is as follows:

This invention extends the current frameworks and architectures for 5G media streaming (5GMS) in order to support AI/ML media services, namely:
The delivery of AI/ML models from the network to the UE for multimedia services.
The selection, configuration, and management of said AI/ML models and their delivery by newly defined network and UE entities, which can consider the 5G network status, UE processing/runtime status and/or capability, and media characteristics, as the input for these decisions related to AI/ML model delivery.
An AI configuration file containing the necessary information to enable the selection, configuration and management of said AI/ML models and their delivery, by either an entity in the network, or an entity in the UE. This AI configuration file created and sent by the network to the UE, which can also update and send back requests to the network.
The AI configuration file containing information that can also include a possibility of different delivery method pipelines for delivering the AI/ML model, namely: complete download, partial download in a streamed manner, topology information download/update, and parameter information download/update.
The AI configuration file may also contain information to indicate the optional support of split inferencing between the network and UE, which can be selected either by the UE or the network.

Results of invention of various embodiments of the present disclosure are as follows:

The following is enabled by this invention:
Network status, UE status and multimedia context driven AI/ML model selection, delivery and management between network and UE for multimedia services

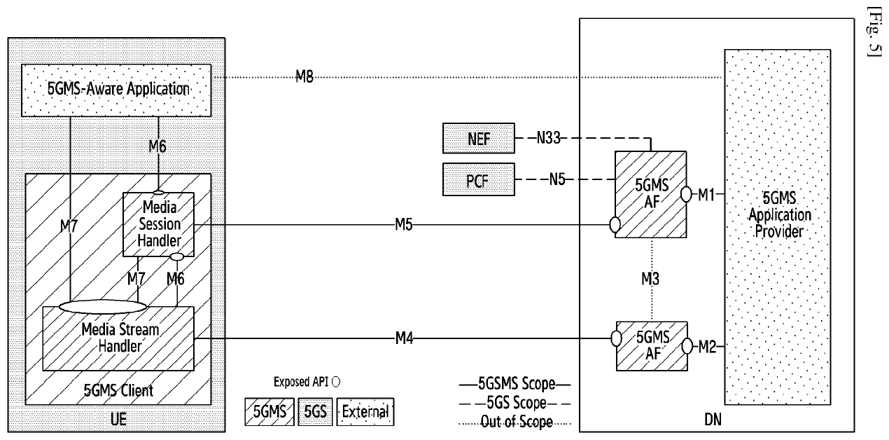

FIG. 4 shows the overall 5G Media Streaming Architecture in TS 26.501, representing the specified 5GMS functions within the 5GS as defined TS 23.501.

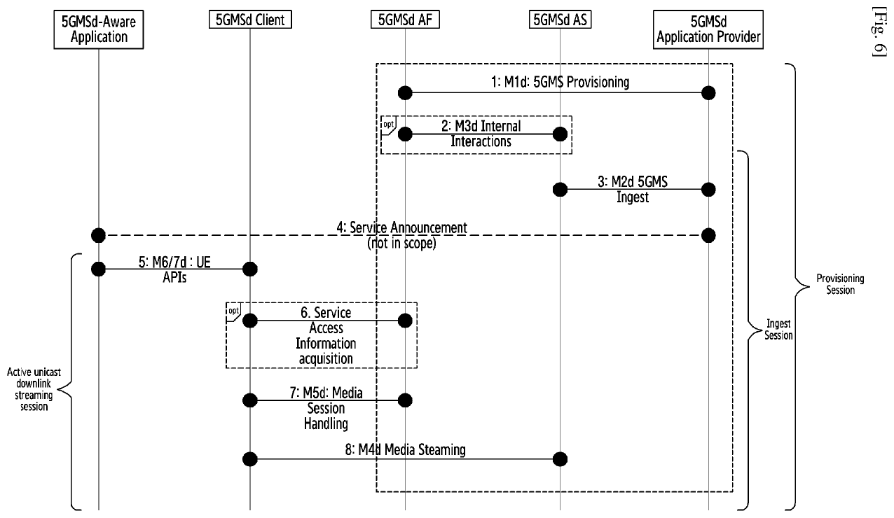

FIG. 5 shows the 5G Media Streaming General Architecture from TS 26.501, identifying which media streaming functional entities and interfaces are specified within the specification.

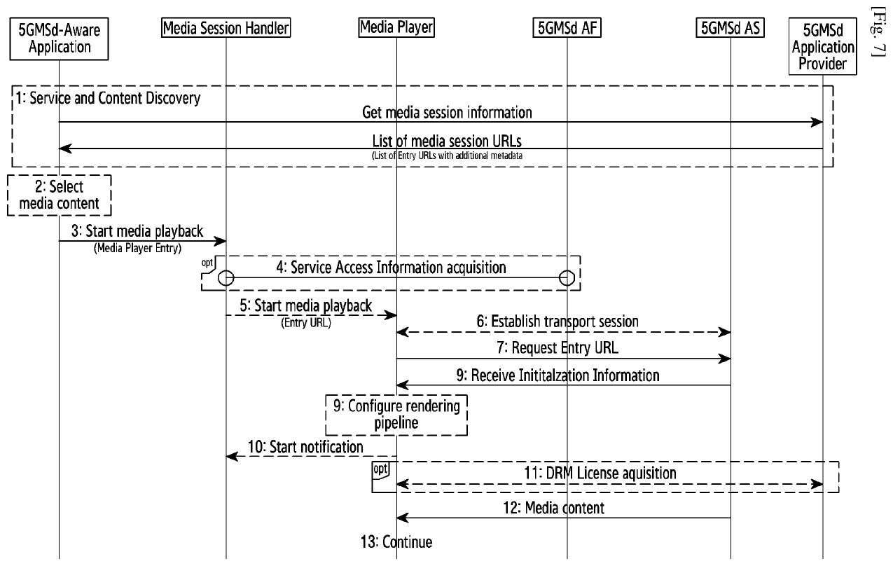

FIG. 6 shows the high level procedure for media downlink streaming as specified in TS 26.501.

FIG. 7 shows, for reference, the baseline procedure describing the establishment of a unicast media downlink streaming session as defined by TS 26.501.

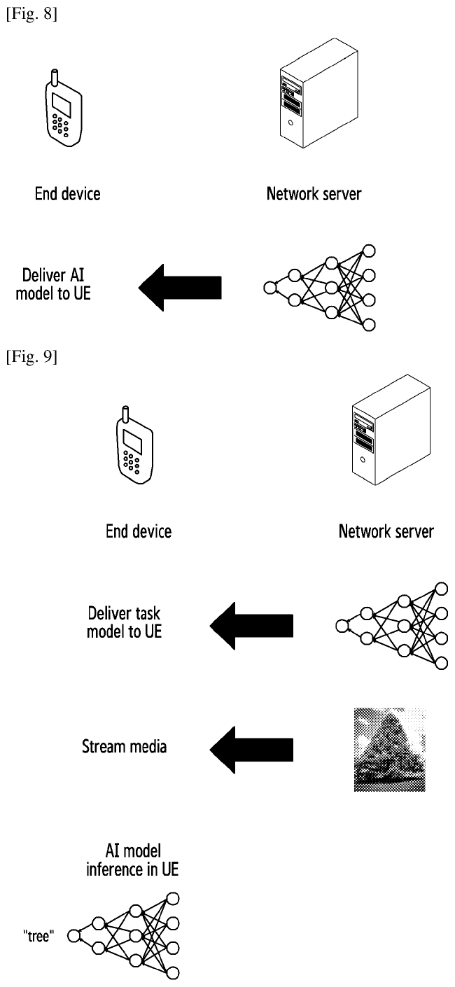

FIG. 8 shows a simple AI/ML media service scenario where an AI/ML model is required to be delivered from the network to the UE (end device). Upon receiving the AI model, the UE device performs the inferencing of the model, feeding the relevant media as an input into the AI model.

A typical example:
John is in Seoul for his summer vacation, and he is in Jamsil wanting to visit Lotte Tower for sightseeing. John cannot read Korean, and finds it difficult to navigate his way to Lotte Tower.
John takes out his mobile phone (UE), and opens an augmented reality navigation service on it. His network operator provides the service via 5G, and through the analysis of different information, a suitable AI model is delivered to his mobile phone. Such information includes information available from the network, such as John's UE's location, his charging policy, network availability and conditions (bandwidth, latency) etc, his UE's processing capabilities and status, as well as the media properties which will be used as the input to the AI model.
Once the AI model is delivered to John's phone, the AR navigation service initiates the camera on the phone to capture the John's surroundings.
The captured video from the phone's camera is fed as the input into the AI model, and the AI model inferencing is initiated.
The output of the AI model provides direction labels (such as navigation arrows) which are shown as overlays in the phone's screen live camera in order to guide John to Lotte Tower. Road signs in Korean are also overlayed by English labels output from the AI model.

FIG. 9 shows a scenario where an AI model is delivered to the UE, and also where media (such as video) is also streamed to the UE. In the UE, the streamed video is fed as an input into the received AI model for processing.

The AI model may perform any media related processing, for example: video upscaling, video quality enhancement, vision applications such as object recognition, facial recognition, etc.

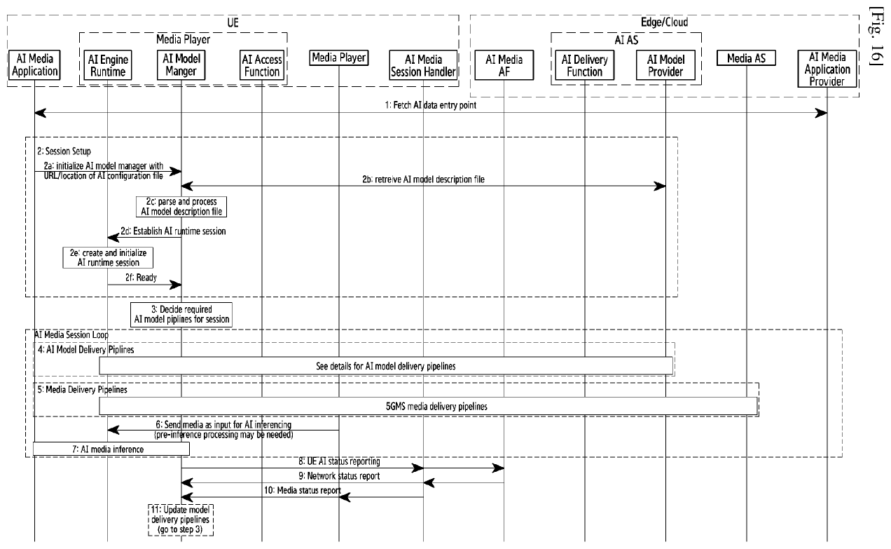

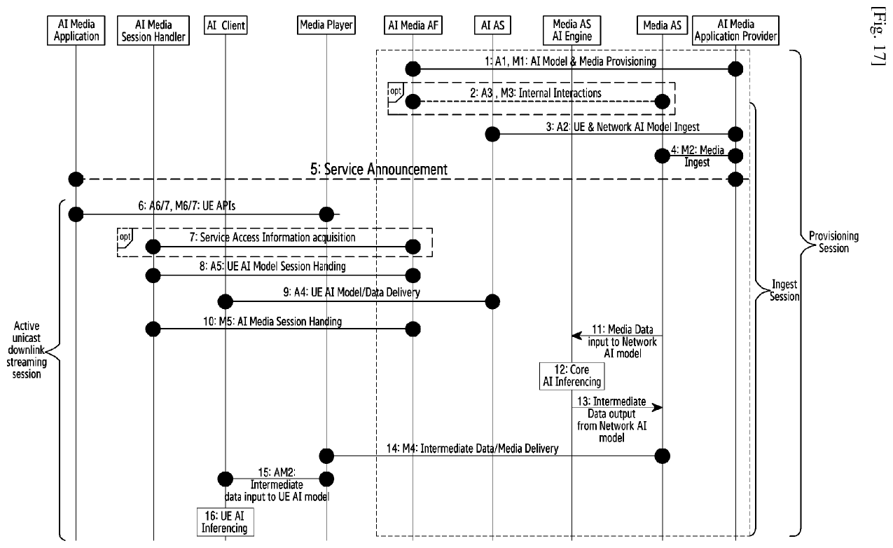

A simple description of the required steps is (see FIGS. 15 and 16 for concrete details):
Service announcement
Request/selection by UE or network (which task UE wants to perform, takes into account media requirements, network status parameters, UE status parameters, network or UE selects suitable AI model)
Provision & ingest model in network
Provision media in network
Session(s) establishment(s)
Delivery AI model from network to UE
Configure media session downlink
Stream media from network
AI media inference in UE

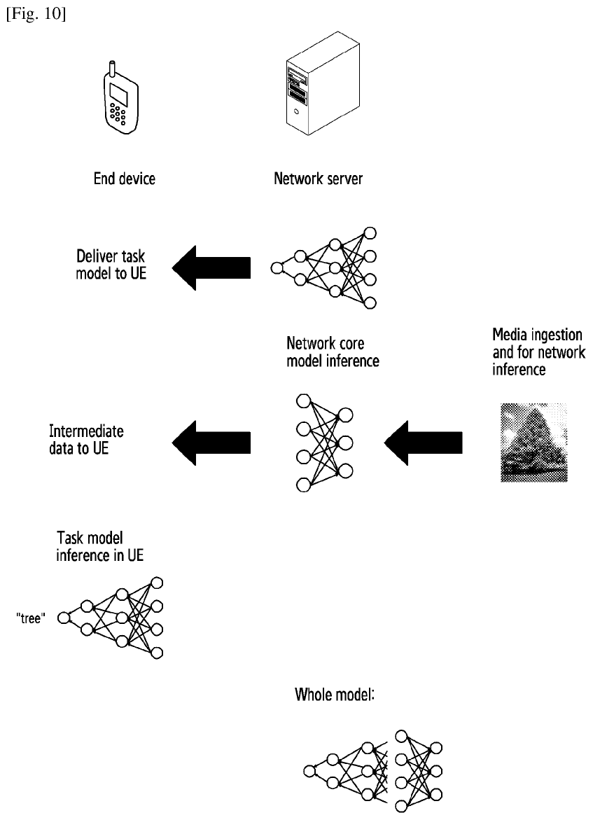

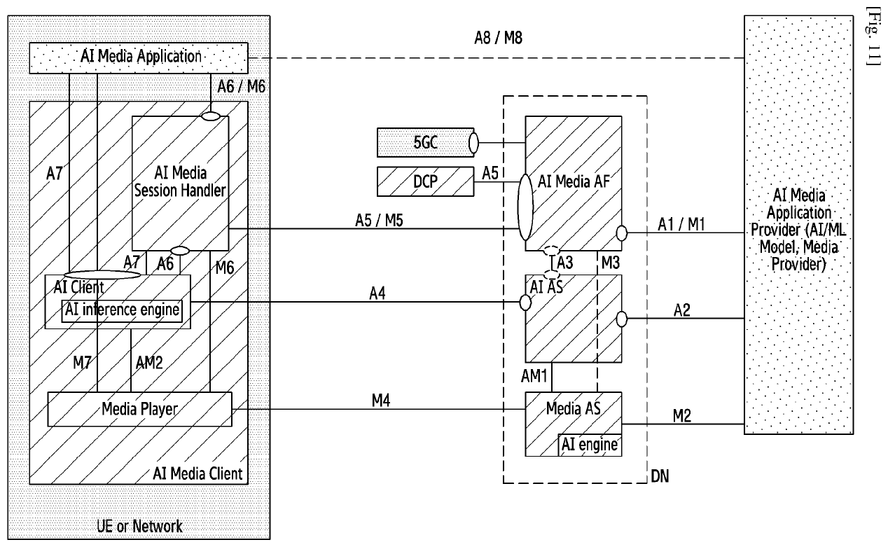

FIG. 10 shows a scenario where the inferencing required for the AI media service is split between the network and UE. A portion of the AI model to be inferenced on the UE is delivered from network to the UE. Another portion of the AI model to be inferenced in the network is provisioned by the network to an entity which performs the inferencing in the network. The media for inferencing is firstly provisioned and ingested by the network to the network inferencing entity, when feeds the media as an input into the network portion of the AI model. The output of the network side inference (intermediate data) is then sent to the UE, which received this intermediate data and feeds it as an input into the UE side portion of the AI model, hence completing the inference of the whole model.

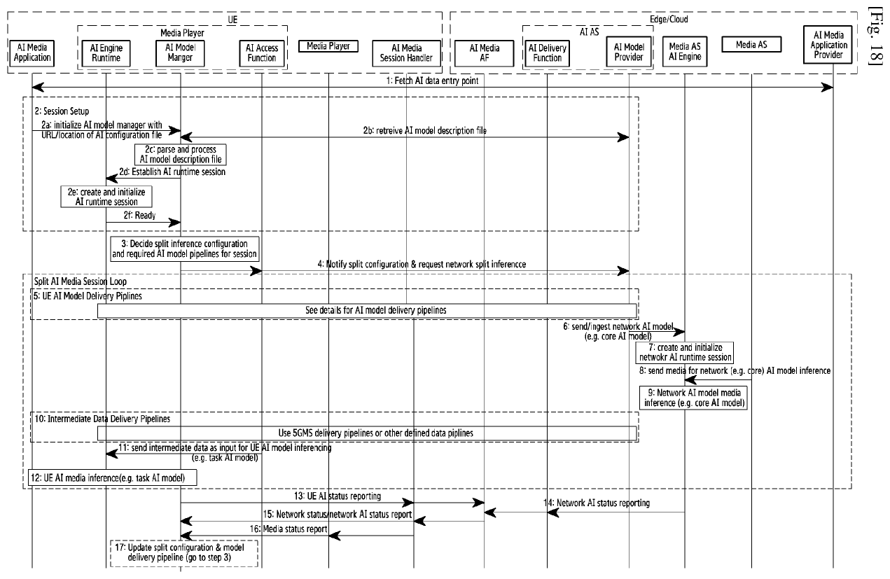

In this scenario, the split decision and configuration is negotiated between the UE and the network, and a simple description of the required steps is (see FIGS. 17 and 18 for concrete details):
Service announcement
Request/selection by UE (which task it wants to perform, gives media requirements, AF selects suitable model head)
Provision UE task model head and core model in network
Provision media in network
Split configuration setup & establishment
Session(s) establishment(s)
Configure intermediate data session downlink
Download/stream model head from network
Perform network core model inference
Stream intermediate data from network
Task model inference in UE

In one split configuration example, an AI model service may consist of a core portion, as well as a task specific portion (e.g. traffic sign recognition task, or facial recognition task), where the core portion of the AI model is common to multiple possible tasks. In this case, the split configuration may coincide the core and task portions in a manner such that the network performs the inference of the core portion of the model, and the UE (receives and) performs the inference of the task portion of the model.

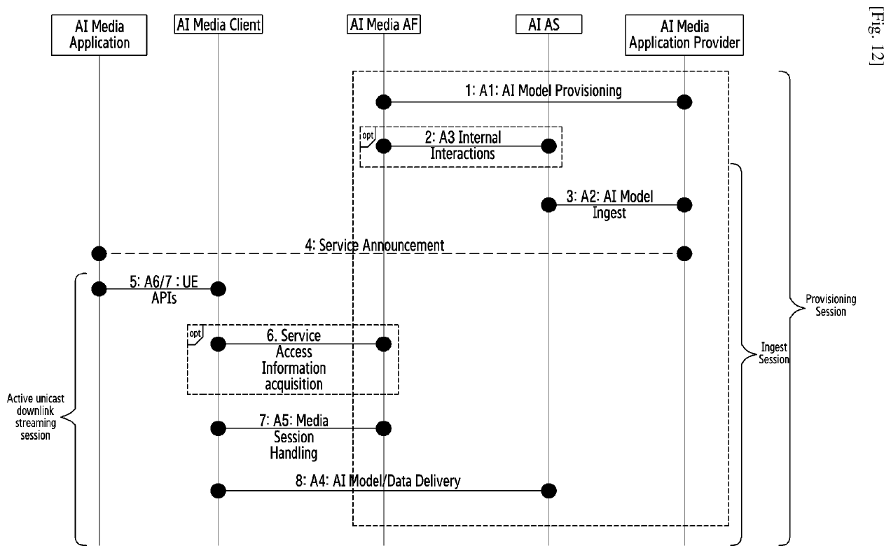

FIG. 11 shows and AI for media (AI4Media) architecture which identifies the various functional entities and interfaces for enabling AI model delivery for media services in this invention. “M” interfaces correspond to interfaces specified in TS 26.501, whilst “A” interfaces are defined by the contents of this invention. “AM” interfaces correspond to interfaces within the scope of both 5GMS (TS 26.501) as well as the scope of the contents in this invention.

AI Media AF: An Application Function similar to that defined in TS 23.501 clause 6.2.10, dedicated to AI media services. Typically provides various control functions to the AI Media Session Handlers on the UE and/or to the AI Media Application Provider. It may interact with other 5GC network functions, such as a Data Collection Proxy (DCP) function entity (which interacts with the AI/ML Endpoint and/or 3GPP Core Network to collect information required for the AI Media AF). The DCP may or may not include NWDAF function/functionality.

AI AS: An Application Server dedicated to AI media services, which hosts 5G AI media (sub) functions, such as the AI Delivery Function and AI Model Provider function as shown in FIG. 13. The AI AS typically supports AI model hosting by ingesting AI models from an AI Media Application Provider, and egesting models to other network functions for network inferencing, such as the Media AS.

Media AS: Corresponds to the Media AS in TS 26.501, but may also include an AI engine function, which performs AI model inferencing.

AI Media Application Provider: External application, with content-specific media functionality, and/or AI-specific media functionality (AI model creation, splitting, updating etc.).

The AI Media Client in the UE contains three subfunctions:

AI Media Session Handler: a function on the UE that communications with the AI Media AF in order to establish, control and support the delivery of an AI model session, and/or a media session, and may perform additional functions such as consumption and QoE metrics collection and reporting. The AI Media Session Handler may expose APIs that can be used by the AI Media Application.

AI Client: a function on the UE that communicates with the AI AS in order to download/stream (or even upload) the AI model data, and may provide APIs to the AI Media Application for AI model inferencing (AI Engine Runtime in FIG. 13), and to the AI Media Session Handler for AI model session control (AI Model Manager for managing AI models (e.g. ONNX file) in the UE, and AI Access Function for accessing AI model data such as topology data and or AI model parameters (weights, biases).

Media Player: a function on the UE corresponding to the same as specified in TS 26.501. A Media Player may egest media content to the AI Client as data input for AI model inferencing in the AI Client.

In another embodiment of this invention, the AI inference engine in the UE may exist in the Media Player instead of the AI Client. It may also exist in another function in the UE.

In another embodiment of this invention, the AI engine in the network may exist in the AI AS instead of the Media AS.

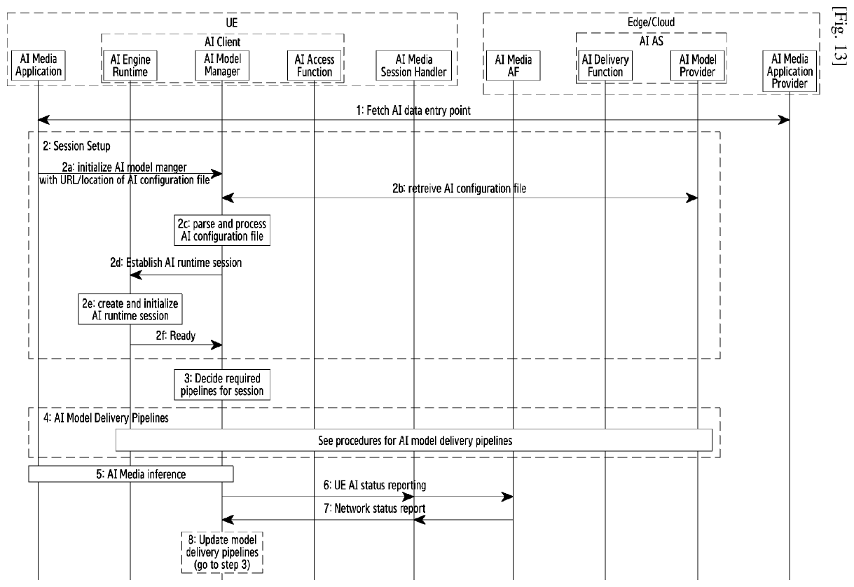

FIG. 12 shows a high level procedure for AL model downlink delivery, corresponding to the scenario in FIG. 8.

### Steps:

1. The AI Media Application Provider creates a Provisioning Session with the AI Media AF and starts provisioning the usage of the AI4Media System. During the establishment phase, the used features are negotiated and detailed configurations are exchanged. The AI Media AF receives Service Access Information for A5 (AI Model Session Handling) and, where AI model data hosting is negotiated, Service Access Information for A2 (Ingestion) and A4 (AI model data delivery) as well. This information is needed by the AI Media Client to access the service. Depending on the provisioning, only a reference to the Service Access Information might be supplied.

2. When AI Model Data Hosting is offered and selected there may be interactions between the AI Media AF and the AI AS, e.g. to allocate AI model data ingest and distribution resources. The AI AS provides resource identifiers for the allocated resources to the AI Media AF, which then provides the information to the AI Media Application Provider.

3. The AI Media Application Provider starts the Ingest Session by ingesting AI model data. In case of dynamic AI model AI media services, the AI model data may be continuously ingested or may be uploaded once and then updated later on.

4. The AI Media Application Provider provides the Service Announcement Information to the AI Media Application. The service announcement includes either the whole Service Access Information (i.e. details for AI Model Session Handling (A5) and for AI model data delivery access (A4), e.g. including AI configuration file) or a reference to the Service Access Information or pre-configured information. When only a reference is included, the AI Media Client fetches (in step 6) the Services Access Information (including e.g. the AI configuration file) when needed.

5. When the AI Media Application decides to begin receiving AI model data, the Service Access Information (all or a reference) is provided to the AI Media Client. The AI Media Client activates the unicast downlink delivery session.

6. Optional) In case the AI Media Client received only a reference to the Service Access Information, then it acquires the Service Access Information from the AI Media AF.

7. The AI Media Client uses the AI Model Data Session Handling API exposed by the AI Media AF at A5. The AI Model Data Session Handling API is used for configuring consumption measurement, logging, collection and reporting; configuring QoE metrics measurement, logging, collection and reporting; requesting different policy and charging treatments; or AI Media AF-based Network Assistance. The actual time of API usage depends on the feature and interactions that may be used during the media content reception.

8. The AI Media Client activates reception of the AI model data.

For all embodiments in this invention, the service announcement includes either:
1) the whole Service Access Information (i.e. details for AI Model Session Handling (A5) and/or Media Session Handling (M5), and for AI model data delivery access (A4) and/or media content data access (M5), including an AI configuration file, or
2) a reference to the Service Access Information or pre-configured information.

This information is needed by the AI Media Client to access the service.

FIG. 13 shows a basic workflow procedure for the scenario in FIG. 8.

### Steps:

1. The application contacts the application provider to fetch the entry point for the AI media service. The acquisition of the entry point may be performed in different manners. An entry point may for example be a URL to an AI configuration file.

2. Session set up:

2a. In case when the entry point is a URL of an AI configuration file, the application initializes the AI Model Manager using the acquired entry point.

2b. The AI Model Manager retrieves the AI configuration file from the AI Model Provider based on the entry point information.

AI configuration file contains:
General descriptions for the AI media service
A list of AI models available for selection for the AI media service (indicated through identifiers).
For each AI model in the list:
An identifier/identifiers pointing to the location of the actual AI model data (e.g. URL(s))
General descriptions for the AI model, including metadata describing the different parameters of the AI model, such as model neural network type (CNN, DNN etc.), topology information, the number of layers, whether the model contains complete or partial layer data, number of filters, kernels, biases, quantized weights, tensors etc.
The AI configuration file may also contain information related to the delivery of the available AI models. In particular, whether the AI model data can be downloaded as a whole file (or similar), whether the AI model can be delivered as partial models (and whether they can be inferenced independently or not), whether the AI model data can be delivered according to the different data types (such as topology data separately, parameter data (weights, biases etc.) separately etc.)
The AI configuration file may also contain information regarding the possible inferencing configurations possible for the AI media service, such as possible network-UE split inferencing configurations, which may or may not be dependent on the AI model selected.

In one embodiment of the invention, the AI Media AF may receive information from the UE regarding the UE's capability, status and requirements (such as processing capability, media requirements for AI model processing, model inference buffer capacity etc.). The AI Media AF may also receive information from the 5GS regarding UE/network status, such as network condition (e.g. congestion, bandwidth, latency), UE location, UE charging policy etc.) and also other relevant information. The AI Media AF then uses these information (from UE and 5GS) in order to select one AI model for the AI media service, and provides the relevant AI model configuration information to the UE (e.g. model location URL, model general descriptions etc.).

In another embodiment, the AI Media AF uses these information to pre-select a set of suitable AI models from those provisioned from the AI Media Application Provider. The AI Media AF then updates the AI configuration file to include the configuration information related to the selected AI models (e.g. AI model data location URL, AI model general description properties such as model type, number of layers etc.), and sends the updated AI configuration file to the UE. Using this updated configuration file, the AI Model Manager in the UE selects one suitable AI model for the service.

In another embodiment, the AI Media AF does not perform a preselection of the AI models, and instead sends the relevant network status/condition information (obtained from the 5GS) to the UE. The UE then, upon receiving both the AI configuration file and network information, uses all the available information (including that available internally from the UE) in order to decide and select a suitable AI model for the service.

2c. The AI Model Manager parses the AI configuration file and processes the AI configuration file. The AI Model Manager may also select a suitable AI model for the AI media service from the AI configuration file. It may also decide the required AI model data delivery pipelines needed for the selected AI model during this step.

2d. The AI Model Manager requests the creation of an AI runtime session from the AI Engine Runtime.

2e. The AI Engine Runtime initializes an AI runtime session, ready for ingestion of an AI model for inferencing.

2f. The AI Engine Runtime notifies the AI Model Manager of its ready state.

3. The AI Model Manager may select a suitable AI model for the AI media service from the AI configuration file (if it did not do so during step 2c). The AI Model Manager also decides the required AI model data delivery pipelines (including metadata) needed for the selected AI model, using information from the AI configuration file during this step (if it did not do so during step 2c).

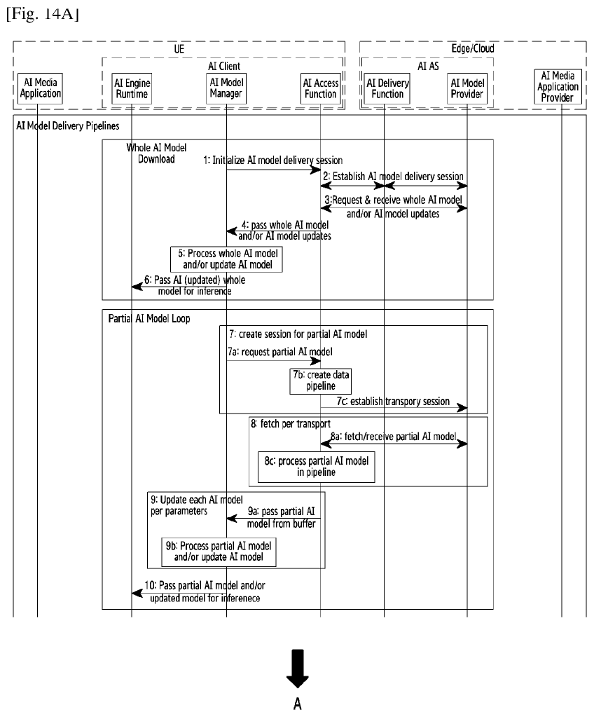

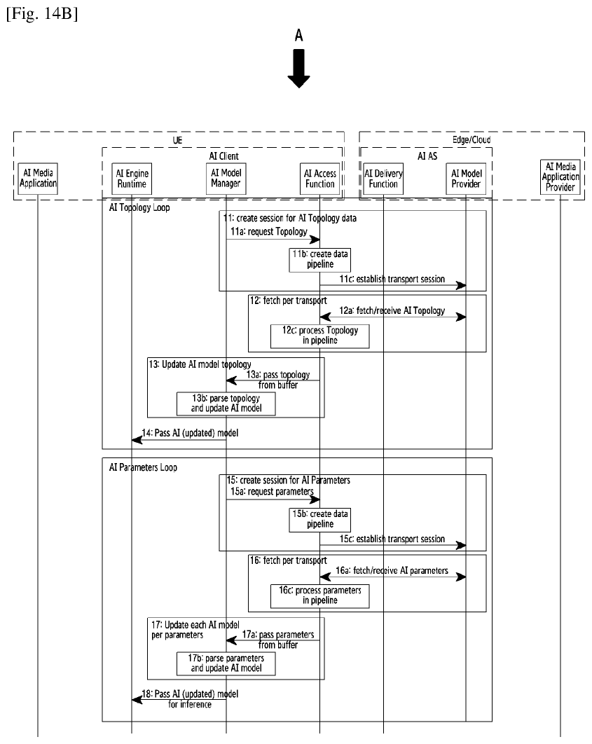

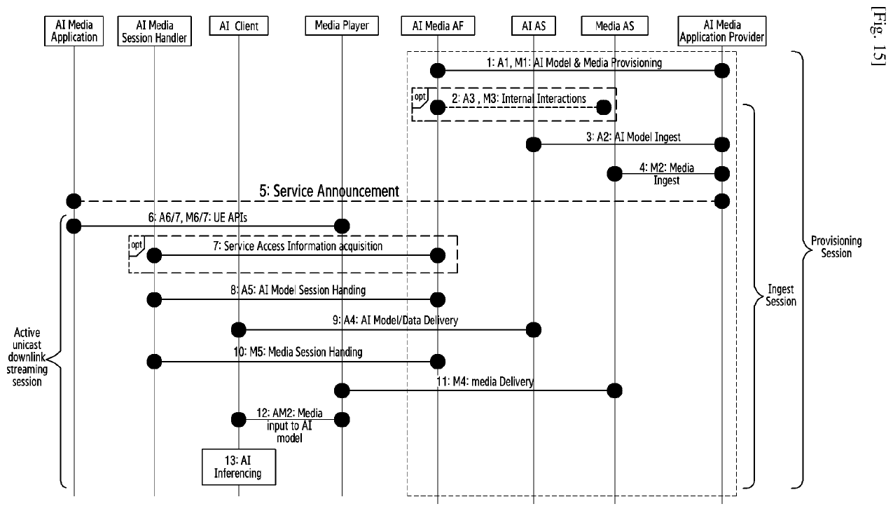

4. AI Model Delivery Pipelines: possible pipelines for the delivery of AI model data, as decided in step 3. Details are given in FIGS. 14A and 14B. Once established, these AI Model Delivery Pipelines enable the delivery of AI model data from the AI AS to the UE via A4.

5. The UE inferences the AI model with the relevant media as an input, for the AI media service.

6. UE may send status reports regarding its AI media service status (e.g. AI inference status, latency, resource status, capability status, dynamic media properties etc.) to the AI Media AF. This step may occur before step 3, or even step 2c (i.e. before the selection of an AI model and its delivery pipelines), such that these information can be shared and used for the decision processes in step 3 and 2c.

7. The AI Media AF may send network related status/condition reports to the UE. This step may occur before step 3, or even step 2c (i.e. before the selection of an AI model and its delivery pipelines), such that these information can be shared and used for the decision processes in step 3 and 2c.

Steps 6 and 7 enable the sharing of UE and network status information between the two endpoints. Such information may be used by either the UE or network in order to make decisions related to the selection of an AI model from the AI configuration file, selection of the multiple required delivery pipelines, any split inference configurations required (where necessary), and any updates of either the AI configuration file itself, or any of the decisions as listed above, during the AI media service.

8. Depending on the internal functions, conditions, and information from step 6 and/or step 7, the UE may reselect the AI model for the AI media service, and/or may also reselect/redecide/update the delivery pipelines for AI model data delivery.

FIG. 14A and FIG. 14B show the various AI model delivery pipelines from step 4 in FIG. 13.

The UE or network may decide to setup and use a variety of different pipelines to deliver the AI model data from the network to the UE.

### Whole AI Model Download:

The whole AI model may be delivered in a download manner (e.g. download of a file) to the UE, where inferencing on the UE is performed only after all the data for the whole AI model is received.

### Partial AI Model Loop:

The AI model may be delivered in a partial download manner. For delivery in a partial manner, the AI model is divided into multiple partial models in the network. Such partial models may or may not be independently inferencable, depending on the implementation. Partial models may be delivered to the UE in a stream-like manner, where each partial model is delivered consecutively. For independently inferencable partial models, inferencing on the UE may occur before the whole AI model data is received (e.g. UE inferencing of the first partial model may occur after the receipt of the first partial model data, before the receipt of the second partial model's data).

### AI Topology Loop:

The AI topology data of the AI model may be delivered separately from the rest of the data associated with the AI model.

### AI Parameters Loop:

The data for the AI parameters (e.g. node parameters such as weights, biases etc) may be delivered separately from the other data associated with the AI model (i.e. separate from the topology data).

One or more of the possible delivery pipelines may be selected and setup for AI model data delivery, and the loop frequency of each pipeline may be different, depending on the AI model characteristics and properties as specified by the data in the AI configuration file (e.g. the parameters pipeline may loop at a frequency corresponding to the required update of the parameters over the duration of the AI media service).

FIG. 15 shows a high level procedure for AL model downlink delivery & media content streaming delivery, corresponding to the scenario in FIG. 9, where the AI media service involves both AI model delivery and media streaming delivery to the UE.

### Steps:

1. The AI Media Application Provider creates a Provisioning Session with the AI Media AF and starts provisioning the usage of the AI4Media System (as well as the 5GMS system for media streaming). During the establishment phase, the used features are negotiated and detailed configurations are exchanged. The AI Media AF receives Service Access Information for A5 and M5 (AI Model Session Handling and Media Session Handling) and, where AI model data and media content hosting is negotiated, Service Access Information for A2/M2 (Ingestion) and A4/M4 (AI model data delivery and media content delivery) as well. This information is needed by the AI Media Client to access the service. Depending on the provisioning, only a reference to the Service Access Information might be supplied.

2. When AI Model Data Hosting is offered and selected there may be interactions between the AI Media AF and the AI AS/Media AS, e.g. to allocate both AI model data and media content ingest and distribution resources. The AI AS and Media AS provides resource identifiers for the allocated resources to the AI Media AF, which then provides the information to the AI Media Application Provider.

3. The AI Media Application Provider starts the AI Model Ingest Session by ingesting AI model data. In case of dynamic AI model AI media services, the AI model data may be continuously ingested or may be uploaded once and then updated later on.

4. The AI Media Application Provider starts the Media Ingest Session by ingesting media content. In case of live media services, the media content may be continuously ingested or may be uploaded once and then updated later on.

5. The AI Media Application Provider provides the Service Announcement Information to the AI Media Application. The service announcement includes either the whole Service Access Information (i.e. details for AI Model Session Handling (A5), Media Session Handling (M5) and for AI model data delivery access (A4), media content delivery access (M4) e.g. including AI configuration file) or a reference to the Service Access Information or pre-configured information. When only a reference is included, the AI Media Client fetches (in step 6) the Services Access Information (including e.g. the AI configuration file) when needed.

6. When the AI Media Application decides to begin receiving AI model data and media content data, the Service Access Information (all or a reference) is provided to the AI Media Client. The AI Media Client activates the unicast downlink delivery session.

7. Optional) In case the AI Media Client received only a reference to the Service Access Information, then it acquires the Service Access Information from the AI Media AF.

8. The AI Media Client uses the AI Model Data Session Handling API exposed by the AI Media AF at A5. The AI Model Data Session Handling API is used for configuring consumption measurement, logging, collection and reporting; configuring QoE metrics measurement, logging, collection and reporting; requesting different policy and charging treatments; or AI Media AF-based Network Assistance. The actual time of API usage depends on the feature and interactions that may be used during the media content reception.

9. The AI Media Client activates reception of the AI model data.

10. The AI Media Client uses the Media Session Handling API exposed by the AI Media AF at M5. The Media Session Handling API is used for configuring consumption measurement, logging, collection and reporting; configuring QoE metrics measurement, logging, collection and reporting; requesting different policy and charging treatments; or AI Media AF-based Network Assistance. The actual time of API usage depends on the feature and interactions that may be used during the media content reception.

11. The AI Media Client activates reception of the content data.

12. The Media Player passes the received streamed media content to the AI Client.

13. The AI Client performs AI inferencing of the received AI model using the streamed media content as input into the model.

FIG. 16 shows the basic workflow procedure for the scenario in FIG. 9, which is an extension of the basic workflow procedure as described in FIG. 13.

Steps 1 to 3 of FIG. 16 correspond to the steps 1 to 3 of FIG. 13, and steps 7 to 9 of FIG. 16 correspond to steps 5 to 7 of FIG. 13. Step 11 of FIG. 16 corresponds to step 8 of FIG. 13.

AI configuration file contains:
General descriptions for the AI media service
A list of AI models available for selection for the AI media service (indicated through identifiers).
For each AI model in the list:
An identifier/identifiers pointing to the location of the actual AI model data (e.g. URL(s))
General descriptions for the AI model, including metadata describing the different parameters of the AI model, such as model neural network type (CNN, DNN etc.), topology information, the number of layers, whether the model contains complete or partial layer data, number of filters, kernels, biases, quantized weights, tensors etc.
The AI configuration file may also contain information related to the delivery of the available AI models. In particular, whether the AI model data can be downloaded as a whole file (or similar), whether the AI model can be delivered as partial models (and whether they can be inferenced independently or not), whether the AI model data can be delivered according to the different data types (such as topology data separately, parameter data (weights, biases etc.) separately etc.)
The AI configuration file may also contain information regarding the possible inferencing configurations possible for the AI media service, such as possible network-UE split inferencing configurations, which may or may not be dependent on the AI model selected.

In one embodiment of the invention, the AI Media AF may receive information from the UE regarding the UE's capability, status and requirements (such as processing capability, media requirements for AI model processing, model inference buffer capacity etc.). The AI Media AF may also receive information from the 5GS regarding UE/network status, such as network condition (e.g. congestion, bandwidth, latency), UE location, UE charging policy etc.) and also other relevant information. The AI Media AF then uses these information (from UE and 5GS) in order to select one AI model for the AI media service, and provides the relevant AI model configuration information to the UE (e.g. model location URL, model general descriptions etc.).

In another embodiment, the AI Media AF uses these information to pre-select a set of suitable AI models from those provisioned from the AI Media Application Provider. The AI Media AF then updates the AI configuration file to include the configuration information related to the selected AI models (e.g. AI model data location URL, AI model general description properties such as model type, number of layers etc.), and sends the updated AI configuration file to the UE. Using this updated configuration file, the AI Model Manager in the UE selects one suitable AI model for the service.

In another embodiment, the AI Media AF does not perform a preselection of the AI models, and instead sends the relevant network status/condition information (obtained from the 5GS) to the UE. The UE then, upon receiving both the AI configuration file and network information, uses all the available information (including that available internally from the UE) in order to decide and select a suitable AI model for the service.

All the different embodiments as described under FIG. 13 are also applicable to the details in FIG. 16.

In addition to the delivery of AI model data via AI Model Delivery Pipelines, FIG. 16 also includes the delivery of media content data from network to UE via media delivery pipelines, at the most basic level using the media delivery pipelines defined in 5GMS (TS 26.501).

In step 3, the AI Client may also decide the required media delivery pipelines for the AI media session.

### Steps:

4. See FIGS. 14A and 14B.

5. Media delivery pipelines: possible pipelines for the delivery of media content data from the Media AS to the AI Media Client. Delivery maybe in the form of media streaming delivery, or download delivery, or any other form of delivery mechanism required by the AI media service. One such typical service is defined by 5GMS (TS 26.501).

6. On receiving the media data, the Media Player sends the media data to the AI client to be used as the input for AI inference. Any media processing required before being used as the AI model input is also performed at this stage, either in the Media Player or in any other relevant entity (e.g. media decoding, downscaling/upscaling etc.)

10. The AI Client may receive media status reports either from the network (through the AI Media Session Handler), or internally from the Media Player, in order to be used for updating AI model selection decisions and/or also for updating the decisions for the model delivery pipelines used for both AI Model data and also media content data.

FIG. 17 shows a high level procedure for a split inferencing AI media service, corresponding to the scenario in FIG. 10, where the AI media service involves both AI model inferencing in the network, and also the UE (where the UE receives a IE AI model, and also the intermedia data from the network).

### Steps:

1. The AI Media Application Provider creates a Provisioning Session with the AI Media AF and starts provisioning the usage of the AI4Media System (as well as the 5GMS system for media streaming). During the establishment phase, the used features are negotiated and detailed configurations are exchanged. The AI Media AF receives Service Access Information for A5 and M5 (AI Model Session Handling and Media Session Handling) and, where AI model data and media content hosting is negotiated, Service Access Information for A2/M2 (Ingestion) and A4/M4 (AI model data delivery and media content delivery) as well. This information is needed by the AI Media Client to access the service. Depending on the provisioning, only a reference to the Service Access Information might be supplied.

2. When AI Model Data Hosting is offered and selected there may be interactions between the AI Media AF and the AI AS/Media AS, e.g. to allocate both AI model data and media content ingest and distribution resources. The AI AS and Media AS provides resource identifiers for the allocated resources to the AI Media AF, which then provides the information to the AI Media Application Provider.

3. The AI Media Application Provider starts the AI Model Ingest Session by ingesting AI model data. In case of dynamic AI model AI media services, the AI model data may be continuously ingested or may be uploaded once and then updated later on. For split inferencing between the network and the UE, both the UE AI Model(s) and the Network AI Model(s) required by the AI media service are ingested.

4. The AI Media Application Provider starts the Media Ingest Session by ingesting media content. In case of live media services, the media content may be continuously ingested or may be uploaded once and then updated later on.

5. The AI Media Application Provider provides the Service Announcement Information to the AI Media Application. The service announcement includes either the whole Service Access Information (i.e. details for AI Model Session Handling (A5), Media Session Handling (M5) and for AI model data delivery access (A4), media content delivery access (M4) e.g. including AI configuration file) or a reference to the Service Access Information or pre-configured information. When only a reference is included, the AI Media Client fetches (in step 6) the Services Access Information (including e.g. the AI configuration file) when needed.

6. When the AI Media Application decides to begin receiving AI model data and media content data, the Service Access Information (all or a reference) is provided to the AI Media Client. The AI Media Client activates the unicast downlink delivery session.

7. Optional) In case the AI Media Client received only a reference to the Service Access Information, then it acquires the Service Access Information from the AI Media AF.

8. The AI Media Client uses the AI Model Data Session Handling API exposed by the AI Media AF at A5. The AI Model Data Session Handling API is used for configuring consumption measurement, logging, collection and reporting; configuring QoE metrics measurement, logging, collection and reporting; requesting different policy and charging treatments; or AI Media AF-based Network Assistance. The actual time of API usage depends on the feature and interactions that may be used during the media content reception.

9. The AI Media Client activates reception of the UE AI model data.

10. The AI Media Client uses the Media Session Handling API exposed by the AI Media AF at M5, for the intermedia data to be sent from the network to the UE. The Media Session Handling API is used for configuring consumption measurement, logging, collection and reporting; configuring QoE metrics measurement, logging, collection and reporting; requesting different policy and charging treatments; or AI Media AF-based Network Assistance. The actual time of API usage depends on the feature and interactions that may be used during the media content reception.

11. The Media AS passes the ingested media data to the AI Engine in the network, ready as an input for network AI inference. In the case that the network AI model has not been previously passed to the AI Engine (e.g. during ingestion), the AI AS or Media AS may also pass the network AI model to the network AI Engine at this stage.

12. On receiving the media data, the network AI Engine performs the network AI inference using the media data from step 11 as the input.

13. The output data (intermediate data) of the network AI model inference from step 12 is sent to the Media AS ready for delivery to the UE.

14. The AI Media Client and/or Media AS activates delivery of the intermediate data, which may also be media data, depending on the AI media service characteristics.

15. The Media Player passes the intermediate data/media data to the AI Client.

16. The UE AI Client performs UE side device AI inferencing of the received UE AI model (received in step 9) using the received intermediate data from step 14 as input into the model.

FIG. 18 shows the basic workflow procedure for the scenario in FIG. 9, which is an extension of the basic workflow procedure as described in FIG. 16.

Steps 1 to 3 of FIG. 18 correspond to the steps 1 to 3 of FIG. 16, step 5 to step 4, step 10 to step 5, step 11 to step 6, step 12 to step 6 etc.

AI configuration file contains:
General descriptions for the AI media service
A list of AI models available for selection for the AI media service (indicated through identifiers).
For each AI model in the list:
An identifier/identifiers pointing to the location of the actual AI model data (e.g. URL(s))
General descriptions for the AI model, including metadata describing the different parameters of the AI model, such as model neural network type (CNN, DNN etc.), topology information, the number of layers, whether the model contains complete or partial layer data, number of filters, kernels, biases, quantized weights, tensors etc.
The AI configuration file may also contain information related to the delivery of the available AI models. In particular, whether the AI model data can be downloaded as a whole file (or similar), whether the AI model can be delivered as partial models (and whether they can be inferenced independently or not), whether the AI model data can be delivered according to the different data types (such as topology data separately, parameter data (weights, biases etc.) separately etc.)
The AI configuration file may also contain information regarding the possible inferencing configurations possible for the AI media service, such as possible network-UE split inferencing configurations, which may or may not be dependent on the AI model selected.

In one embodiment of the invention, the AI Media AF may receive information from the UE regarding the UE's capability, status and requirements (such as processing capability, media requirements for AI model processing, model inference buffer capacity etc.). The AI Media AF may also receive information from the 5GS regarding UE/network status, such as network condition (e.g. congestion, bandwidth, latency), UE location, UE charging policy etc.) and also other relevant information. The AI Media AF then uses these information (from UE and 5GS) in order to select one AI model for the AI media service, and provides the relevant AI model configuration information to the UE (e.g. model location URL, model general descriptions etc.).

In another embodiment, the AI Media AF uses these information to pre-select a set of suitable AI models from those provisioned from the AI Media Application Provider. The AI Media AF then updates the AI configuration file to include the configuration information related to the selected AI models (e.g. AI model data location URL, AI model general description properties such as model type, number of layers etc.), and sends the updated AI configuration file to the UE. Using this updated configuration file, the AI Model Manager in the UE selects one suitable AI model for the service.

In another embodiment, the AI Media AF does not perform a preselection of the AI models, and instead sends the relevant network status/condition information (obtained from the 5GS) to the UE. The UE then, upon receiving both the AI configuration file and network information, uses all the available information (including that available internally from the UE) in order to decide and select a suitable AI model for the service.

All the different embodiments as described under FIG. 13 are also applicable to the details in FIG. 18.

In addition to the delivery of AI model data via AI Model Delivery Pipelines, FIG. 18 also includes the delivery of intermediate data from network to UE via media delivery pipelines, at the most basic level using the media delivery pipelines defined in 5GMS (TS 26.501).

In step 3, the AI Client may also decide the required media delivery pipelines for the AI media session.

Step 4: The AI Client notifies the network of the required split inference configuration requested, as decided in step 3.

Steps 6˜9: The required network AI model data (e.g. a core model) is sent to the network AI engine, and the ingested media data is also sent to the AI engine. The network AI engine then performs AI model inferencing using these data, sending the output intermediate data to the UE in step 10, via intermediate data delivery pipelines.

Methods of embodiments described in the claims or specification of the present disclosure may be implemented in the form of hardware, software, or a combination of hardware and software.

When it is implemented by software, a computer-readable storage medium storing one or more programs (software modules) may be presented. One or more programs stored in the computer-readable storage medium are configured for execution by one or more processors in an electronic device. The one or more programs include instructions that cause the electronic device to execute methods of embodiments described in the claims or specification of the present disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs) or other optical storage devices, magnetic cassettes. Or, it may be stored in a memory consisting of a combination of some or all of these. Also, each constructed memory may be included in multiple numbers.

Also, the program may be stored in an attachable storage device that may be accessed through a communication network such as the Internet, an intranet, a local area network (LAN), a wide area network (WAN), or a storage area network (SAN), or a communication network consisting of a combination thereof. Such a storage device may be connected to a device performing an embodiment of the present disclosure through an external port. Also, a separate storage device on a communication network may be connected to a device performing an embodiment of the present disclosure.

In the specific embodiments of the present disclosure described above, components included in the disclosure are expressed in singular or plural number according to the specific embodiments presented. However, the expression of the singular or plural number is selected appropriately for the presented situation for convenience of description, and the present disclosure is not limited to singular or plural components, and even the component expressed in the plural number are composed of the singular number, or even the component expressed in the singular number may be composed of the plural number.

Meanwhile, in the detailed description of the present disclosure, specific embodiments have been described, but various modifications are possible without departing from the scope of the present disclosure. Therefore, the scope of the present disclosure should not be limited to and defined by the described embodiments and should be defined by the scope of the claims described below as well as equivalents to the scope of these claims.

1. A method performed by a user equipment (UE) in a wireless communication system, the method comprising:
receiving, from a first network entity, information regarding at least one artificial intelligence (AI) model;
determining an AI model based on the information regarding at least one AI model;
determining whether to use the AI model for an AI split inference service;
requesting, to the first network entity, the AI split inference service;
establishing an AI model deliver pipeline for the AI model; and
establishing a media deliver pipeline for delivering media data used in the AI model.

2. The method of claim 1,
wherein the information regarding at least one AI model includes a uniform resource locator (URL) to obtain a list the at least one AI model.

3. The method of claim 1, further comprising
receiving, from a second network entity, intermediate data on the media deliver pipeline.

4. The method of claim 1, further comprising
transmitting, to the first network function, a status report regarding information on the AI split inference service.

5. The method of claim 4, further comprising
updating the AI model and the AI model deliver pipeline based on the information on the AI split inference service and information on a network status.

6. A method performed by a first network entity in a wireless communication system, the method comprising:
transmitting, to a user equipment (UE), information regarding at least one artificial intelligence (AI) model;
identifying an AI model determined based on the information regarding at least one AI model;
receiving a request for an AI split inference service using the AI model;
establishing an AI model deliver pipeline for the AI model; and
establishing a media deliver pipeline for delivering media data used in the AI model.

7. The method of claim 6,
wherein the information regarding at least one AI model includes a uniform resource locator (URL) to obtain a list the at least one AI model.

8. The method of claim 6, further comprising:
receiving, from the UE, a status report regarding information on the AI split inference service.

9. The method of claim 8, further comprising:
updating the AI model and the AI model deliver pipeline based on the information on the AI split inference service and information on a network status.

10. The method of claim 6, further comprising:
triggering an inference process in a second network entity.

11. A user equipment (UE) in a wireless communication system, the UE comprising:
at least one transceiver; and
at least one processor operatively coupled with the at least one transceiver,
wherein the at least one processor is configured to:
receive, from a first network entity, information regarding at least one artificial intelligence (AI) model,
determine an AI model based on the information regarding at least one AI model,
determine whether to use the AI model for an AI split inference service, request, to the first network entity, the AI split inference service,
establish an AI model deliver pipeline for the AI model, and
establish a media deliver pipeline for delivering media data used in the AI model.

12. The UE of claim 11,
wherein the information regarding at least one AI model includes a uniform resource locator (URL) to obtain a list the at least one AI model.

13. The UE of claim 11, wherein the at least one processor is further configured to:
receive, from a second network entity, intermediate data on the media deliver pipeline.

14. The UE of claim 11, wherein the at least one processor is further configured to:
transmit, to the first network function, a status report regarding information on the AI split inference service.

15. A first network entity in a wireless communication system, the first network entity comprising:
at least one transceiver; and
at least one processor operatively coupled with the at least one transceiver,
wherein the at least one processor is configured to:
transmit, to a user equipment (UE), information regarding at least one artificial intelligence (AI) model,
identify an AI model determined based on the information regarding at least one AI model,
receive a request for an AI split inference service using the AI model, establish an AI model deliver pipeline for the AI model, and
establish a media deliver pipeline for delivering media data used in the AI model.
